(19) United States
(12) Patent Application Publication
(10) Pub. No.: US 2006/0021328 A1
(43) Pub. Date: Feb. 2, 2006

(54) Exhaust gas recirculation device for an internal combustion engine

(76) Inventors: Johannes Leweux, Esslingen (DE); Harald Tober, Boblingen (DE)

Correspondence Address: KLAUS J. BACH, 4407 TWIN OAKS DRIVE, MURRYSVILLE, PA, 15668, US

(21) Appl. No.: 11/188,304

(22) Filed: Jul. 25, 2005

(30) Foreign Application Priority Data
Jul. 29, 2004 (DE) 102004036762.0

(51) Int. Cl. F01N 3/00; F02M 25/06

(52) U.S. Cl. 60/278; 60/276

(57) ABSTRACT

In an exhaust gas recirculation device for an internal combustion engine, with an intake duct connected to the inlet side of the internal combustion engine and an exhaust duct connected to the outlet side of the internal combustion engine and at least one exhaust gas purification element arranged in the exhaust duct, a second exhaust gas recirculation line is connect the exhaust duct and extends to the intake duct for the recirculation of exhaust gas from different locations of the exhaust duct and a first and a second control element are provided for controlling the exhaust gas flow quantities flowing respectively through the first and the second exhaust gas recirculation line.

### BACKGROUND OF THE INVENTION

The invention relates to an exhaust gas recirculation device for an internal combustion engine and to an exhaust gas recirculation method for an internal combustion engine.

It is generally known, in internal combustion engines, to carry out exhaust gas recirculation (EGR) in order to reduce the emission of pollutants from the internal combustion engine. In this context, part of the exhaust gas is recirculated from the outlet side of the internal combustion engine to the inlet side of the internal combustion engine via a suitable exhaust gas recirculation line and is mixed with the intake air supplied to the engine.

In a conventional embodiment of an EGR, the exhaust gas recirculation line branches off the exhaust duct closely downstream of the outlet of the internal combustion engine and therefore still upstream of the respective exhaust gas purification elements, so that exhaust gas having a high temperature is recirculated. This is advantageous, particularly during a cold start of the internal combustion engine, since the combustion space is additionally heated by the hot exhaust gas stream. When the internal combustion engine is warm, however, the recirculated exhaust gas stream has to be cooled. Owing to the cooling of the unpurified exhaust gas stream, a soot is usually deposited on the EGR components and even on other components.

In a known exhaust gas recirculation device, the EGR is switchable, and, in the event of a cold start of the internal combustion engine, the exhaust gas stream is recirculated through an uncooled region of the EGR, whereas, when the internal combustion engine is warm, the exhaust gas can be recirculated through a cooled region of the EGR.

Furthermore, for example, EP 0 898 647 B1 discloses an EGR, in which the exhaust gas recirculation line branches off only downstream of a catalytic converter and a silencer and directly upstream of the exhaust pipe. Owing to a special shaping of the exhaust pipe, the exhaust gas flow quantity through the exhaust gas recirculation line is automatically reduced when the internal combustion engine is in a high load state. The exhaust gas recirculated through the exhaust gas recirculation line is a purified exhaust gas having a low temperature. The EGR additionally contains an auxiliary exhaust gas recirculation line which branches off directly downstream of the outlet side of the internal combustion engine and also upstream of the catalytic converter and can therefore recirculate a high-temperature exhaust gas stream during a cold start of the internal combustion engine.

DE 199 24 920 A1 describes an EGR with two parallel exhaust gas recirculation lines, one of which is provided with an exhaust gas cooling device. It is specified here that exhaust gas purification elements are arranged in the exhaust train basically in any desired way in relation to the branch-offs of the two exhaust gas recirculation lines.

It is the object of the present invention to provide an exhaust gas recirculation device and an exhaust gas recirculation method which allows an optimum operation of the internal combustion engine and, at the same time, extends the useful life of the EGR components and reduces the emissions of pollutants.

### SUMMARY OF THE INVENTION

In an exhaust gas recirculation device for an internal combustion engine, with an intake duct connected to the inlet side of the internal combustion engine and an exhaust duct connected to the outlet side of the internal combustion engine and at least one exhaust gas purification element arranged in the exhaust duct, a second exhaust gas recirculation line is connect the exhaust duct and extends to the intake duct for the recirculation of exhaust gas from different locations of the exhaust duct and a first and a second control element are provided for controlling the exhaust gas flow quantities flowing respectively through the first and the second exhaust gas recirculation line.

In this exhaust gas recirculation device, fractions of a less purified exhaust gas and fractions of a more purified exhaust gas are recirculated to the inlet side of the internal combustion engine depending on the operating state of the internal combustion engine, so that the latter is operated with an optimal combustion air based on the engine operating state and the pollutant emissions of the engine can therefore be reduced. Moreover, since a less purified exhaust gas stream with a higher temperature and a more purified exhaust gas stream with a lower temperature are available for exhaust gas recirculation, the cooling of the exhaust gas streams normally required when the internal combustion engine is warm, can be at least reduced thus leading to a reduction in energy losses and in the sooting of the EGR components and consequently to a prolongation of the useful life of the latter.

In a particular embodiment of the invention, a plurality of exhaust gas purification elements are arranged in the exhaust train. In this case, at least two of the plurality of exhaust gas purification elements may be provided between the branch-off of the first exhaust gas recirculation line and the branch-off of the second exhaust gas recirculation line, and/or at least one of the plurality of exhaust gas purification elements may be provided upstream of the branch-off of the first exhaust gas recirculation line, and/or at least one of the plurality of exhaust gas purification elements may be provided downstream of the branch-off of the second exhaust gas recirculation line.

In a preferred embodiment of the invention, an exhaust gas cooling device for cooling the exhaust gas stream is arranged in the first and/or the second exhaust gas recirculation line. Preferably, the cooling capacity of the exhaust gas cooling device can in this case be regulated according to the temperature of the exhaust gas stream in the respective exhaust gas recirculation line.

In a further preferred embodiment of the invention, the first and the second exhaust gas recirculation lines are combined upstream of their connection to the intake duct to form a common exhaust gas recirculation line. In this case, a common exhaust gas cooling device may be arranged in the common exhaust gas recirculation line.

The invention will become more readily apparent from the following description of exemplary embodiments of the invention with reference to the accompanying drawings:

### BRIEF DESCRIPTION OF THE DRAWINGS

FIG. 1 shows a diagrammatic illustration of the arrangement of an exhaust gas recirculation device according to a first exemplary embodiment of the present invention;

FIG. 2 shows a diagrammatic illustration of the construction of an exhaust gas recirculation device according to a second exemplary embodiment of the present invention; and

FIG. 3 shows a diagrammatic illustration of the construction of an exhaust gas recirculation device according to a third exemplary embodiment of the present invention.

### DETAILED DESCRIPTION OF EMBODIMENTS OF THE INVENTION

In the following descriptions of the various exemplary embodiments, identical components are designated by the same reference numbers in all the figures.

### First Exemplary Embodiment

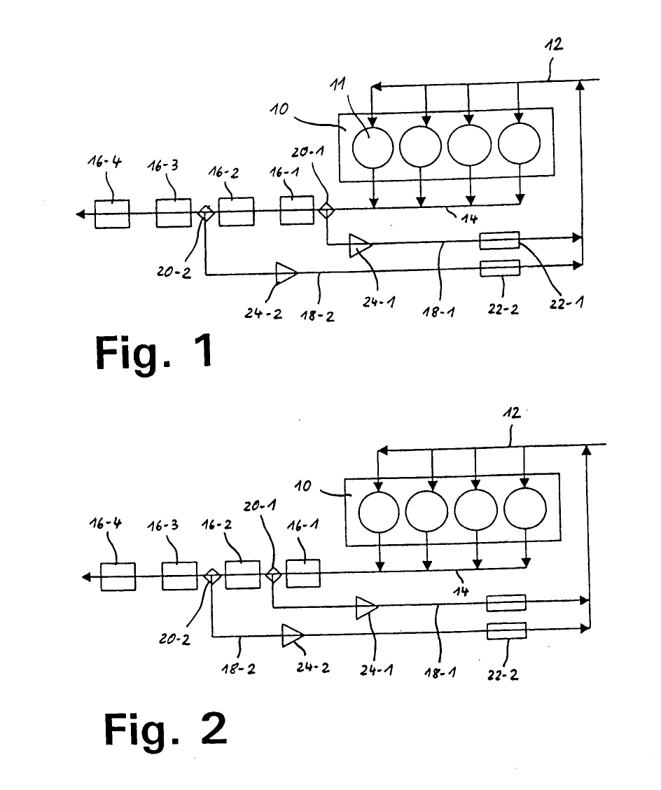

A first exemplary embodiment of the invention is described with reference to FIG. 1. An internal combustion engine 10 having a plurality of cylinders 11 is connected on its inlet side to an intake duct 12 for the supply of combustion air and on its outlet side to an exhaust duct 14 for the discharge of exhaust gases. Further components and the functioning of the internal combustion engine 10 are sufficiently known to a person skilled in the art and are not the subject matter of the present invention. They are therefore not illustrated and explained in detail here. In particular, the present invention is not restricted to a special type of internal combustion engine.

The exhaust duct 14 includes a plurality of exhaust gas purification elements 16-1, 16-2, 16-3, 16-4 (generally designated as 16-n) and, depending on the type of the design, silencers (not illustrated), exhaust gas turbochargers (not illustrated) and the like. Both identical and different devices may be used in the case of the plurality of exhaust gas purification elements 16-n. The present invention is not restricted to special types of exhaust gas purification elements, but suitable exhaust gas purification elements are, for example, diesel particle filters, OXI catalytic converters, NOₓ accumulators, SCR catalytic converters and the like.

The exhaust gas recirculation (EGR) according to the invention is formed from two exhaust gas recirculation lines 18-1 and 18-2. Within the scope of the present invention, however, even more than two such exhaust gas recirculation lines 18-n may be used. In the first exemplary embodiment of FIG. 1, the first exhaust gas recirculation line 18-1 branches off from the exhaust duct 14 upstream of the first exhaust gas purification element 16-1 and recirculates part of the exhaust gas from the exhaust duct 14 to the combustion air in the intake duct 12 of the internal combustion engine 10, while the second exhaust gas recirculation line 18-2 branches off from the exhaust duct 14 between the second exhaust gas purification element 16-2 and the third exhaust gas purification element 16-3 and recirculates part of the exhaust gas from the exhaust duct 14 to the combustion air in the intake duct 12 of the internal combustion engine 10.

Consequently, unpurified exhaust gases having a high temperature are recirculated to the intake duct 12 through the first exhaust gas recirculation line 18-1, while exhaust gas of lower temperature, purified by two exhaust gas purification elements 16-1, 16-2, is re-circulated to the intake train 12 through the second exhaust gas recirculation line 18-2. Whereas, in the first exemplary embodiment of FIG. 1, two exhaust gas purification elements 16-1, 16-2 are provided between the branch-offs of the first and of the second exhaust gas recirculation line 18-1, 18-2 from the exhaust duct 14, within the scope of the invention even only one or more than two exhaust gas purification elements 16-n may be provided between the branch-offs of the first and of the second exhaust gas recirculation line 18-1, 18-2 from the exhaust train 14.

The exhaust gas flow quantities through the first and the second exhaust gas recirculation line 18-1, 18-2 are controlled respectively by a first control element 20-1 at the branch-off of the first exhaust gas recirculation line 18-1 from the exhaust duct 14 and by a second control element 20-2 at the branch-off of the second exhaust gas recirculation line 18-2 from the exhaust duct 14. The present invention is not restricted to a special type of control element 20-n, and, for example, electrically and/or mechanically and/or pneumatically and/or hydraulically driven control elements 20-n, which can be controlled and/or regulated, may be used. The first and the second control element 20-1, 20-2 may optionally be of the same type and of a different type.

The first and the second control element 20-1, 20-2 are activated, according to the invention, in such a way that the less purified exhaust gas flow quantity of higher temperature through the first exhaust gas recirculation line 18-1 and the more purified exhaust gas flow quantity of lower temperature through the second exhaust gas recirculation line 18-2 are controlled according to the operating state of the internal combustion engine 10, so that the internal combustion engine 10 is operated with as optimal combustion air as possible according to the operating state and its pollutant emissions can be reduced. Moreover, since a less purified exhaust gas stream having a higher temperature and a more purified exhaust gas stream having a lower temperature are available for exhaust gas recirculation, the cooling of the exhaust gas streams when the internal combustion engine is warm can be at least reduced, thus leading to a reduction in the sooting of the EGR components.

During a cold start of the internal combustion engine 10, exhaust gas is preferably re-circulated to the intake duct 12 mainly through the first exhaust gas recirculation line 18-1, in order to introduce an exhaust gas stream having as high a temperature as possible into the combustion air. By contrast, when the internal combustion engine 10 is warm, exhaust gas is re-circulated to an increased extent through the second exhaust gas recirculation line 18-2, in order to introduce to the intake air a better purified exhaust gas stream which, moreover, scarcely needs to be cooled additionally.

Furthermore, the first and the second exhaust gas re-circulation line 18-1, 18-2 include in each case an exhaust gas cooling device 22-1 and 22-2 for cooling the respective exhaust gas stream, a nonreturn valve (not illustrated) for preventing a backflow of the exhaust gas out of the respective exhaust gas recirculation line 18-1, 18-2 into the exhaust duct 14, and the like. Alternatively, one-way valves or pumps 24-1 and 24-2 for conveying the respective exhaust gas stream through the exhaust gas recirculation line are provided, in which case, where an arrangement of a plurality of one-way valves is concerned, these may be connected in parallel or in series.

The invention is not restricted to a special type of exhaust gas cooling device 22-n; for example, air/water coolers or air/air coolers may be envisaged. Preferably, the cooling capacity of the exhaust gas cooling devices 22-1, 22-2 can be controlled according to the temperature of the exhaust gas stream in the respective exhaust gas recirculation line 18-1, 18-2 and according to the operating state of the internal combustion engine 10. If appropriate, the exhaust gas cooling device 22-2 may even be dispensed with in the second exhaust gas recirculation line 18-2, if the temperatures of the exhaust gas streams through the second exhaust gas recirculation line 18-2 are in any case very low. The invention is also not restricted to a special type of conveying device 24-n. To conduct the exhaust gas streams through the exhaust gas recirculation lines 18-n to the intake duct 12, both identical and different valve units 24-n may be used, for example electrically and/or mechanically and/or pneumatically and/or hydraulically operated pumping units. Even a combination of the exhaust gas recirculation with the exhaust gas turbocharger as a direct or indirect conveying unit may be envisaged.

Whereas, in FIG. 1, the various components in the exhaust gas recirculation device are illustrated separately, some of these components may also be integrated with one another. Moreover, if required, a plurality of control elements 20-n, exhaust gas cooling devices 22-n and/or conveying units 24-n may also be provided in an exhaust gas re-circulation line 18-n. The pumping units 24-n may, if appropriate, be connected in parallel or in series. Nevertheless, the exhaust gas recirculation device according to the present invention is operable even without a pumping device.

### Second Exemplary Embodiment

A second exemplary embodiment of the present invention, then, is described with reference to FIG. 2. The exhaust gas recirculation device of the second exemplary embodiment differs from the exhaust gas recirculation device illustrated in FIG. 1 in that the first exhaust gas recirculation line 18-1 does not branch off from the exhaust duct 14 upstream of the first exhaust gas purification element 16-1, but only between the first and the second exhaust gas purification element 16-1, 16-2. As a result, in comparison with the first exemplary embodiment, a somewhat more purified exhaust gas having a somewhat lower temperature is recirculated through the first exhaust gas recirculation line 18-1 to the combustion air in the intake duct 12.

The remaining components of the exhaust gas recirculation device are identical to those of the first exemplary embodiment described above, so that the same actions and advantages can also be achieved with the exhaust gas recirculation device of FIG. 2.

### Third Exemplary Embodiment

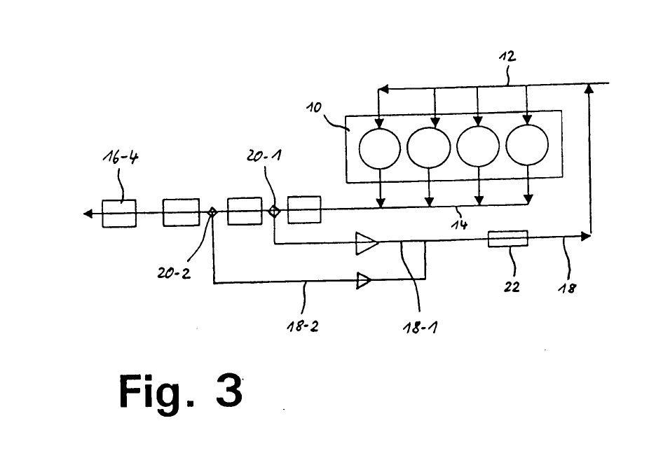

A third exemplary embodiment of the invention is explained with reference to FIG. 3. The exhaust gas recirculation device of the third exemplary embodiment differs from the exhaust gas recirculation device illustrated in FIG. 2 in that the first and the second exhaust gas recirculation line 18-1 and 18-2 are combined to form a common exhaust gas recirculation line 18, in which a mixed exhaust gas stream is recirculated to the intake train 12. In this case, advantageously, only one common exhaust gas cooling device 22 may be provided in the common exhaust gas recirculation line 18 instead of the separate exhaust gas cooling devices 22-1, 22-2 in the separate exhaust gas recirculation lines 18-1, 18-2. In this embodiment, the two exhaust gas streams having a different degree of purity and a different temperature are mixed in the common exhaust gas recirculation line 18, and a mixed exhaust gas stream is recirculated to the combustion air intake duct 12.

The remaining components of the exhaust gas recirculation device are identical to those of the second exemplary embodiment described above, so that the same actions and advantages can also be achieved with the exhaust gas recirculation device of FIG. 3.

Moreover, the embodiment of FIG. 3 may, of course, also be combined with the first exemplary embodiment, illustrated in FIG. 1, of the exhaust gas recirculation device.

What is claimed is:

1. An exhaust gas recirculation device for an internal combustion engine having an inlet side and an outlet side with an intake duct (12) connected to the inlet side of the internal combustion engine (10) and an exhaust duct (14) connected to the outlet side of the internal combustion engine; at least one exhaust gas purification element (16-n) arranged in the exhaust duct (14); a first exhaust gas re-circulation line (18-1) extending from the exhaust duct (14) to the intake duct (12) for the recirculation part of the exhaust gas from the exhaust duct to the intake duct, the first exhaust gas recirculation line (18-1) branching off from the exhaust duct (14) at a point upstream of the at least one exhaust gas purification element (16-n); a first control element (20-1) for controlling the exhaust gas flow quantity flowing through the first exhaust gas recirculation line (18-1); a second exhaust gas recirculation line (18-2) connected between the exhaust duct (14) and the intake duct (12) for the recirculation of at least part of the exhaust gas from the exhaust duct to the intake duct, the second exhaust gas recirculation line (18-2) branching off from the exhaust duct (14) at a point downstream of the at least one exhaust gas purification element (16-n); and a second control element (20-2) for controlling the exhaust gas flow quantity flowing through the second exhaust gas recirculation line (18-2), the first and the second control elements (20-1, 20-2) being activated in such a way that the less purified exhaust gas flow quantity is directed through the first exhaust gas recirculation line (18-1), the more purified exhaust gas flow quantity is directed through the second exhaust gas recirculation line (18-2) and the flow volumes through the recirculation lines are controlled depending on the operating state of the internal combustion engine (10).

2. The exhaust gas recirculation device as claimed in claim 1, wherein a plurality of exhaust gas purification elements (16-n) are arranged in the exhaust duct (14); and wherein at least two of the plurality of exhaust gas purification elements (16-n) are provided between the branch-off of the first exhaust gas recirculation line (18-1) and the branch-off of the second exhaust gas recirculation line (18-2).

3. The exhaust gas recirculation device as claimed in claim 1, wherein a plurality of exhaust gas purification elements (16-n) are arranged in the exhaust duct (14); and wherein at least one of the plurality of exhaust gas purification elements (16-n) is provided upstream of the branch-off of the first exhaust gas recirculation line (18-1).

4. The exhaust gas recirculation device as claimed in claim 1, wherein a plurality of exhaust gas purification elements (16-n) are arranged in the exhaust duct (14); and wherein at least one of the plurality of exhaust gas purification elements (16-n) is provided downstream of the branch-off of the second exhaust gas recirculation line (18-2).

5. The exhaust gas recirculation device as claimed in claim 1, wherein an exhaust gas cooling device (22-1, 22-2) for cooling the exhaust gas stream is arranged in at least one of the first and the second exhaust gas recirculation line (18-1, 18-2).

6. The exhaust gas recirculation device as claimed in claim 5, wherein the cooling capacity of the exhaust gas cooling device (22-1, 22-2) can be regulated according to the temperature of the exhaust gas stream in the respective exhaust gas recirculation line (18-1, 18-2).

7. The exhaust gas recirculation device as claimed in claim 1, wherein the first and the second exhaust gas recirculation lines (18-1, 18-2) are combined upstream of their connection to the intake duct (12) to form a common exhaust gas recirculation line section (18).

8. The exhaust gas recirculation device as claimed in claim 7, wherein a common exhaust gas cooling device (22) is arranged in the common exhaust gas recirculation line section (18).

9. The exhaust gas recirculation device as claimed in claim 2, wherein the plurality of exhaust gas purification elements (16-n) comprise at least two different types of exhaust gas purification elements.

10. The exhaust gas recirculation device as claimed in claim 2, wherein a pumping device (24-1, 24-2) for conveying the exhaust gas stream is arranged in at least one of the first and the second exhaust gas recirculation line (18-1, 18-2).

11. An exhaust gas recirculation method for an internal combustion engine, with an intake duct (12) connected to the inlet side of the internal combustion engine (10) and an exhaust duct (14) connected to the outlet side of the internal combustion engine, and at least one exhaust gas purification element (16-n) arranged in the exhaust duct (14), at least part of the exhaust gas being branched off from the exhaust duct (14) upstream of the at least one exhaust gas purification element (16-n) and being circulated through a first exhaust gas recirculation line (18-1) to the intake duct (12), said method comprising the steps of conducting part of the exhaust gas being branched off from the exhaust duct (14) downstream of the at least one exhaust gas purification element (16-n) through a second exhaust gas recirculation line (18-1) to the intake duct; and controlling the flow quantity of the less purified exhaust gas flowing through the first exhaust gas recirculation line (18-1) and the flow quantity of the more purified exhaust gas flowing through the second exhaust gas recirculation line (18-2) depending on the operating state of the internal combustion engine (10).

12. The exhaust gas recirculation method as claimed in claim 11, with a plurality of exhaust gas purification elements (16-n) being arranged in the exhaust duct (14), wherein the exhaust gas is branched off from the exhaust duct at areas separated by at least two of the plurality of exhaust gas purification elements (16-n).

13. The exhaust gas recirculation method as claimed in claim 11 with a plurality of exhaust gas purification elements (16-n) being arranged in the exhaust duct (14), wherein the exhaust gas is being branched off the exhaust duct downstream of at least one of the plurality of exhaust gas purification elements (16-n).

14. The exhaust gas recirculation method as claimed in one of claim 11, with a plurality of exhaust gas purification elements (16-n) are arranged in the exhaust duct (14), wherein the exhaust gas is branched off the exhaust duct upstream of at least one of the plurality of exhaust gas purification elements (16-n).

15. The exhaust gas recirculation method as claimed in claim 11, wherein the exhaust gas stream in at least the first exhaust gas recirculation line (18-1, 18-2) is cooled.

16. The exhaust gas recirculation method as claimed in claim 15, wherein the exhaust gas flow in the respective exhaust gas recirculation line (18-1, 18-2) is controlled as a function of the temperature of the exhaust gas stream.

17. The exhaust gas recirculation method as claimed in claim 11, wherein the exhaust gas in at least one of the first and the second exhaust gas recirculation line (18-1, 18-2) is pumped.
